(19) United States
(12) Patent Application Publication
(10) Pub. No.: US 2009/0265058 A1
(43) Pub. Date: Oct. 22, 2009

(54) VEHICLE INCLINATION ANGLE DETECTOR, POWER SOURCE CONTROL APPARATUS HAVING THE VEHICLE INCLINATION ANGLE DETECTOR AND VEHICLE COMPRISING THE SAME

(75) Inventors: Hitoshi Hasegawa, Shizuoka (JP); Yuichi Sasaki, Shizuoka (JP); Yohei Sakashita, Shizuoka (JP)

Correspondence Address: JONES DAY, 555 SOUTH FLOWER STREET FIFTIETH FLOOR, LOS ANGELES, CA, 90071, US

(73) Assignee: Yamaha Hatsudoki Kabushiki Kaisha

(21) Appl. No.: 12/418,497

(22) Filed: Apr. 3, 2009

(30) Foreign Application Priority Data
Apr. 17, 2008 (JP) 2008-108360

(51) Int. Cl. G06F 19/00

(52) U.S. Cl. 701/29; 701/99; 701/104

(57) ABSTRACT

A vehicle inclination angle detector is configured to suppress the difference between an actual vehicle inclination angle and a calculated vehicle inclination angle to allow for stable detection of the same. The detector includes a vertical acceleration sensor, a lateral acceleration sensor, an inclination angle calculating module and a calculation cancelling module. A detection direction of the vertical acceleration sensor with respect to the vehicle is determined such that its acceleration in the gravity direction is detected when the vehicle is in a non-inclined state. Acceleration in the lateral direction is detected when the vehicle is in the non-inclined state. The inclination angle calculating module calculates an inclination angle of the vehicle in the lateral direction based on the detected vertical acceleration and the lateral acceleration. The calculation cancelling module cancels the inclination angle calculation when the detected vertical acceleration and the lateral acceleration satisfy a predetermined error detection condition.

### PRIORITY INFORMATION

This patent application is based on and claims priority under 35 U.S.C. §119 to Japanese Patent Application No. 2008-108360, filed on Apr. 17, 2008, the entire contents of which is hereby expressly incorporated by reference.

### TECHNICAL FIELD

The present invention relates to a vehicle inclination angle detector for detecting an inclination angle of a vehicle in a lateral direction. The invention also relates to a power source control apparatus which controls operation of a power source of a vehicle in accordance with an inclination angle detected by the vehicle inclination angle detector, and to a vehicle having the power source control apparatus. Examples of the vehicle are a straddle-type vehicle such as a motorcycle and a four-wheeled vehicle. Examples of the power source are an engine and an electric motor.

### BACKGROUND

An apparatus for detecting a lateral direction inclination angle of a motorcycle is disclosed, for example, in Japanese Laid-open Patent Application Publication No. 2004-093537 (paragraphs 0085 to 0096, FIGS. 11 and 12). This apparatus includes a vertically installed acceleration sensor and a horizontally installed acceleration sensor. The vertically installed acceleration sensor is mounted on a vehicle body along a direction perpendicular to the ground when the vehicle body is not inclined, and detects a vertical acceleration of the vehicle. The horizontally installed acceleration sensor is mounted on a vehicle body along a lateral direction which is horizontal to the ground when the vehicle body is not inclined, and detects a lateral acceleration of the vehicle body. If gravity acceleration g and inclination angle θ in the lateral direction of a vehicle are used, vertical acceleration A_{Z} detected by the vertically installed acceleration sensor is expressed as A_{Z}=g·cos θ. Similarly, lateral acceleration A_{Y} detected by the horizontally installed acceleration sensor is expressed as A_{Y}=g·sin θ. Therefore, the inclination angle θ can be obtained by θ=tan⁻¹(A_{Y}/A_{Z}) using the vertical acceleration A_{Z} and lateral acceleration A_{Y}. It is possible to control fuel supply, fuel injection and to stop ignition using the inclination angle θ obtained in this manner.

According to the above-described conventional technique, a calculation of the inclination angle θ becomes unreliable in some cases depending upon the particular situation. For example, when a motorcycle is driven on a bumpy road, the vehicle body may be brought into a gravity-free state or a front wheel may be brought up higher than a rear wheel as the vehicle body moves vertically. In such a case, the calculated inclination angle becomes unreliable, and the actual inclination angle and the calculated inclination angle become different from each other.

Hence, it is an object of the present invention to provide a vehicle inclination angle detector which is capable of suppressing the difference between the actual inclination angle and the calculated inclination angle of the vehicle and which is capable of reliably detecting the inclination angle.

### SUMMARY

The vehicle inclination angle detector of the present invention detects an inclination angle in a lateral direction of a vehicle. In one embodiment, the vehicle inclination angle detector includes a vertical acceleration sensor which detects vertical acceleration of the vehicle, a lateral acceleration sensor which detects lateral acceleration of the vehicle, an inclination angle calculating module which calculates an inclination angle in the lateral direction of the vehicle based on the vertical acceleration and the lateral acceleration respectively detected by the vertical acceleration sensor and the lateral acceleration sensor, and a calculation cancelling module which cancels inclination angle calculation carried out by the inclination angle calculating module when the vertical acceleration and the lateral acceleration, respectively detected by the vertical acceleration sensor and the lateral acceleration sensor, satisfy a predetermined error detection condition.

According to the invention, when the vertical acceleration and the lateral acceleration detected by the vertical acceleration sensor and the lateral acceleration sensor, respectively, satisfy a predetermined error detection condition, the calculation of the inclination angle is canceled. With this setup, a difference between the actual inclination angle and the calculated inclination angle of the vehicle is suppressed, and the inclination angle of the vehicle can be reliably detected.

### BRIEF DESCRIPTION OF THE DRAWINGS

FIG. 1 is a schematic side view showing the structure of a vehicle, such as a motorcycle, according to a first embodiment of the invention.

FIG. 2 schematically shows a structure relating to an engine.

FIG. 3 is a block diagram of an electrical structure concerning control of the engine.

FIG. 4 schematically shows the acceleration detection directions of a vertical acceleration sensor and a lateral acceleration sensor, and an inclination angle in the lateral direction of the motorcycle.

FIG. 5A is a diagram showing a relationship between the inclination angle and output voltage of the vertical acceleration sensor.

FIG. 5B is a diagram showing a relationship between the inclination angle and output voltage of the lateral acceleration sensor.

FIG. 6 is a diagram showing a relationship between the inclination angle and the inverse tangent function of the ratio of the lateral acceleration and the vertical acceleration.

FIG. 7 is a diagram showing outputs of the vertical acceleration sensor and the lateral acceleration sensor when the motorcycle is driven on a bumpy road, and a calculation result of the inclination angle.

FIG. 8 is a flowchart illustrating a control operation which is executed by an ECU based on output signals of the vertical acceleration sensor and the lateral acceleration sensor.

FIG. 9 graphically shows a determination made by the ECU concerning the inclination angle in the lateral direction.

FIG. 10 graphically shows a setting example of a minute output region I.

FIG. 11A graphically shows another setting example of the minute output region I.

FIGS. 11B and 11C are diagrams showing one example of region determination processing.

FIG. 12 is a diagram illustrating region determination by a map.

FIG. 13 graphically shows a second embodiment of the invention and, more specifically, a structure of a triaxial acceleration sensor unit.

FIG. 14 is a graph showing the output characteristics of a back-and-forth acceleration sensor.

FIG. 15 is a flowchart depicting a control operation executed by the ECU based on output signals of the vertical acceleration sensor, the lateral acceleration sensor and the back-and-forth acceleration sensor.

FIG. 16 graphically shows a spherical minute output region.

FIGS. 17A, 17B and 17C graphically show other setting examples of the minute output region.

FIG. 18 a flowchart illustrating a processing example of the ECU which can be applied instead of the processing methodology shown in FIG. 15

FIG. 19 graphically shows another example of the minute output region.

### DETAILED DESCRIPTION

Embodiments of the present invention will be explained in detail with reference to the accompanying drawings.

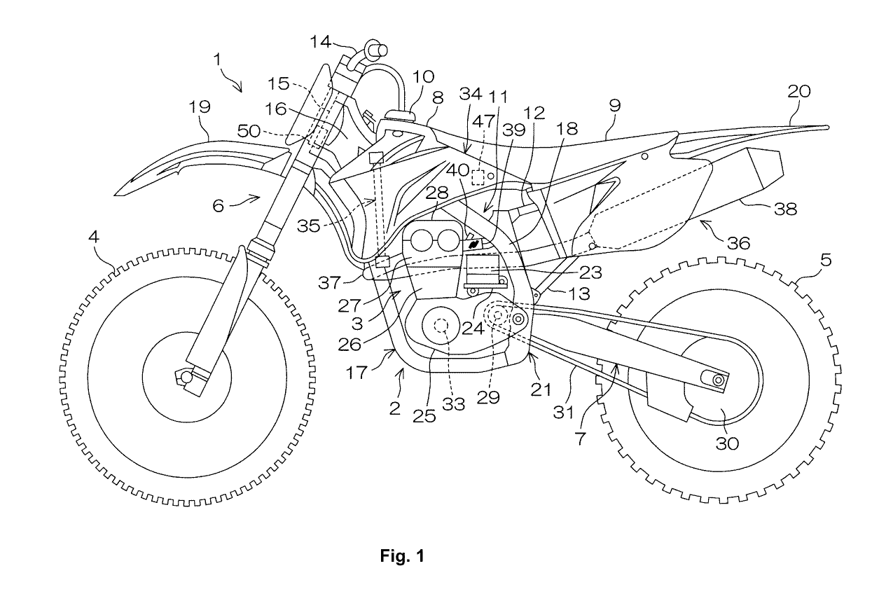

FIG. 1 is a side view showing the structure of a vehicle, such as a motorcycle 1, according to an embodiment of the invention. The motorcycle 1 is a motocross vehicle. The motorcycle 1 includes a vehicle body frame 2, an engine 3, a front wheel 4 and a rear wheel 5. The vehicle body frame 2 includes a main frame 11, a seat rail 12 and a seat support 13. The engine 3 is mounted on the main frame 11. A front fork 6 is supported by a front portion of the main frame 11. A rear arm 7 is supported by a rear portion of the main frame 11.

The main frame 11 includes a head pipe 15, a gazette portion 16, a pair of left and right down tubes 17, and a pair of left and right tank rails 18. The head pipe 15 is provided on a front end of the main frame 11. The gazette portion 16 is a flat member extending rearward and diagonally downward of the vehicle from the head pipe 15. The pair of down tubes 17 spread outward and extend diagonally downward from a lower end of the gazette portion 16 in the lateral direction of the vehicle body (width direction of the vehicle) and extend rearward of the vehicle body. The pair of tank rails 18 are coupled to rear ends of the pair of down tubes 17.

The front fork 6 is supported by the head pipe 15. With this setup, the front fork 6 can rotate leftward and rightward. The front wheel 4 is pivotally supported by a lower end of the front fork 6. A steering handle 14 is fixed to an upper end of the front fork 6. A front fender 19 is disposed above the front wheel 4. The front fender 19 is supported by the front fork 6.

A pair of rear arm brackets 21 are provided on left and right lower portions of the rear end of the main frame 11. The rear arm 7 is supported by the rear arm brackets 21. With this setup, the rear arm 7 can rock in the vertical direction around its end on the side of the rear arm brackets 21. The rear wheel 5 is supported by the rear end of the rear arm 7. A rear suspension (not shown) is interposed between the rear arm 7 and the main frame 11.

The tank rails 18 and the down tubes 17 of the main frame 11 form a cradle. The engine 3 is mounted on the cradle. The engine 3 can be, for example, a water-cooled four-cycle one cylinder engine. The engine 3 is provided at its lower portion with a crankcase 25 in which a crankshaft 33 is accommodated. A cylinder block 26 is coupled to a front portion of the crankcase 25. A cylinder head 27 and a head cover 28 are laminated on the cylinder block 26 in this order. A battery 23 is held on a rear portion of the crankcase 25 through a bracket 24.

A transmission mechanism (not shown) which transmits rotation of the crankshaft 33 to an output shaft 29 is incorporated in the crankcase 25. A chain 31 is wound between the output shaft 29 and a sprocket 30 fixed to the rear wheel 5. With this setup, rotation of the output shaft 29 is transmitted to the rear wheel 5 through the chain 31.

The fuel tank 8 is disposed above the engine 3 and is supported by main frame 11. A fuel cap 10 is detachably attached to an upper wall of the fuel tank 8. A seat 9 is disposed behind the fuel tank 8. The seat 9 is supported by the seat rail 12. The seat rail 12 is coupled to a rear end of an upper portion of the main frame 11. A rear fender 20 covering the rear wheel 5 from above is disposed on a lower side of the seat 9.

A pair of left and right radiators 35 for cooling the engine with cooling water are provided above a front side of the engine 3. A left side, a right side and a rear side of the left and right radiators 35 are covered with a pair of left and right side covers 34. The left and right side covers 34 function as air scoops for introducing air to the left and right radiators 35, and also function as knee grips for a rider.

An air exhaust port opens from a front wall of the cylinder head 27 of the engine 3. An air exhaust pipe 37 of an air exhaust apparatus 36 is connected to the air exhaust port. The air exhaust pipe 37 is bent rearward, and is connected to a muffler 38 disposed above a front side of the rear wheel 5.

An air intake port opens from a rear wall of the cylinder head 27. A throttle body 39 is connected to the air intake port. A fuel injector 40 is provided on the throttle body 39 on the side of the cylinder head 27.

A fuel pump 47, which supplies fuel to the fuel injector 40, is provided in the fuel tank 8. An engine control unit (ECU) 50, which functions as a power source control apparatus for controlling the fuel injector 40 and the fuel pump 47, is provided between two pipes of the front fork 6.

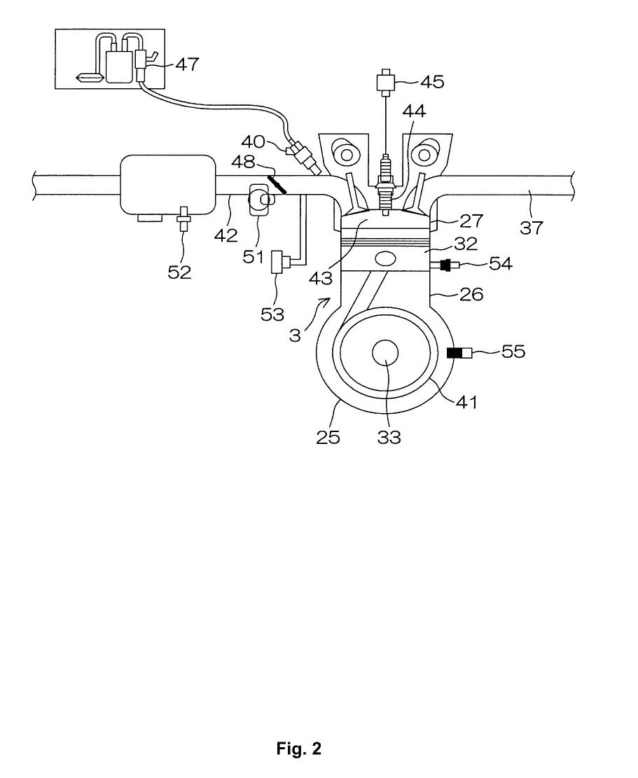

FIG. 2 schematically shows a structure relating to the engine 3. The engine 3 includes the crankcase 25, the cylinder block 26, which is coupled to the crankcase 25, a cylinder head 27 coupled to a head of the cylinder block 26, and a piston 32 accommodated in the cylinder block 26. The crankshaft 33 is rotatably supported in the crankcase 25. A rotor of a power generator (ACM) 41 is coupled to the crankshaft 33. Therefore, the power generator 41 generates electromotive force by rotation of the crankshaft 33.

An air intake pipe 42 and the air exhaust pipe 37 are coupled to the cylinder head 27, and are in communication with a combustion chamber 43 above a piston 32. The spark plug 44 is mounted on the cylinder head 27, and a discharging portion of the spark plug 44 is located in the combustion chamber 43. Discharging voltage is applied to the spark plug 44 from an ignition coil 45.

The fuel injector 40 is mounted on an intermediate portion of the air intake pipe 42. Fuel stored in the fuel tank 8 is supplied to the fuel injector 40 by the fuel pump 47. A throttle valve 48, a throttle opening degree sensor 51, an air intake temperature sensor 52, and an air intake pressure sensor 53 are mounted on the air intake pipe 42. The degree of opening of the throttle valve 48 is varied in accordance with a rider's throttle operation. The throttle valve 48 is disposed upstream within the air intake pipe 42 in the air flowing direction. The throttle opening degree sensor 51 detects the position of the throttle valve 48, thereby detecting its opening degree. The air intake temperature sensor 52 detects a temperature of air introduced into the air intake pipe 42. The air intake pressure sensor 53 is disposed between the throttle valve 48 and the fuel injector 40, and detects the air pressure in the air intake pipe 42.

A water temperature sensor 54 is mounted on the cylinder block 26, and a crank angle sensor 55 is mounted on the crankcase 25. The water temperature sensor 54 detects the temperature of cooling water which cools the engine 3. The crank angle sensor 55 detects the rotation angle of the crankshaft 33.

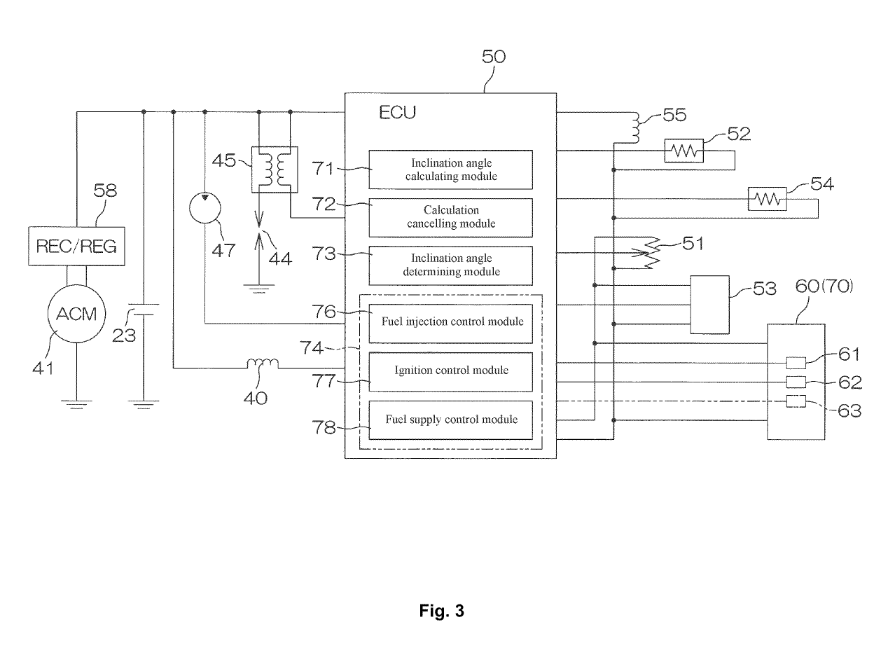

FIG. 3 is a block diagram of an electrical structure concerning control of the engine 3. Alternating current (AC) generated by AC power generator or module (ACM) 41 is rectified by a rectifier/regulator (REC/REG, “regulator”, hereinafter) 58 into direct current (DC) and then smoothed. Electricity produced by the regulator 58 is supplied to the battery 23, the fuel injector 40, the ignition coil 45, the fuel pump 47 and engine control module (ECU) 50. With this setup, the battery 23 can be recharged, and the fuel injector 40, the ignition coil 45, the fuel pump 47 and the ECU 50 can operate. The ECU 50 turns current to the fuel injector 40, the ignition coil 45 and the fuel pump 47 ON/OFF. More specifically, the ECU 50 includes switching elements respectively connected to the fuel injector 40, the ignition coil 45 and the fuel pump 47, and a microcomputer which turns the switching elements ON/OFF. With this setup, the fuel injector 40, the ignition coil 45 and the fuel pump 47 can be operated or stopped.

If the fuel pump 47 is brought into an operating state to operate the fuel injector 40, fuel can be injected from the fuel injector 40 into the air intake pipe 42. With this setup, air-fuel mixture can be sent into the combustion chamber 43. By operating the ignition coil 45, high voltage is applied to the spark plug 44 and a discharge is generated at the discharging portion disposed in the combustion chamber 43. As a result, the air-fuel mixture in the combustion chamber 43 can be ignited and burned.

The throttle opening degree sensor 51, the air intake temperature sensor 52, the air intake pressure sensor 53, the water temperature sensor 54 and the crank angle sensor 55 are operatively connected to the ECU 50. An acceleration sensor unit 60 is also operatively connected to the ECU 50. The acceleration sensor unit 60 is used for detecting the inclination angle of the motorcycle 1 in the lateral direction.

Although the acceleration sensor unit 60 is illustrated as being disposed on the outer side of the ECU 50 in FIG. 3, the acceleration sensor unit 60 is actually, in a preferred implementation, accommodated in a housing of the ECU 50. That is, the acceleration sensor unit 60 is integrally formed with the ECU 50, and they are handled as one part. In this embodiment, the acceleration sensor unit 60 is a biaxial sensor unit including a vertical acceleration sensor 61 and a lateral acceleration sensor 62.

The ECU 50 controls the fuel injector 40 (fuel injection control), the spark plug 44 (ignition control), and the fuel pump 47 (fuel supply control) based on detection signals from the sensors 51 to 55 and 60.

The ECU 50 includes a computer having a CPU and memory. The computer executes a predetermined program that configures and the ECU 50, in the present embodiment, to function as a plurality of processing modules, with each one performing a specific function. The plurality of processing modules include, in the present embodiment, an inclination angle calculating module 71, a calculation cancelling module 72, an inclination angle determining module 73, and an operation control module 74. The inclination angle calculating module 71 calculates an inclination angle of the motorcycle 1 in the lateral direction based on the vertical and lateral acceleration components which are respectively detected by the vertical acceleration sensor 61 and the lateral acceleration sensor 62. When a predetermined error detection condition is satisfied, the calculation cancelling module 72 cancels the inclination angle calculated by the inclination angle calculating module 71. The inclination angle determining module 73 determines whether the inclination angle of the motorcycle 1 exceeds a predetermined inclination angle threshold value. The operation control module 74 controls the operation of the engine 3 in accordance with the determination result of the inclination angle determining module 73.

The operation control module 74 includes a fuel injection control module 76 which controls operation of the fuel injector 40, an ignition control module 77 which controls operation of the spark plug 44, and a fuel supply control module 78 which controls operation of the fuel pump 47. These control modules 76, 77 and 78 are configured to stop the engine 3 based on the determination result of the inclination angle determining module 73.

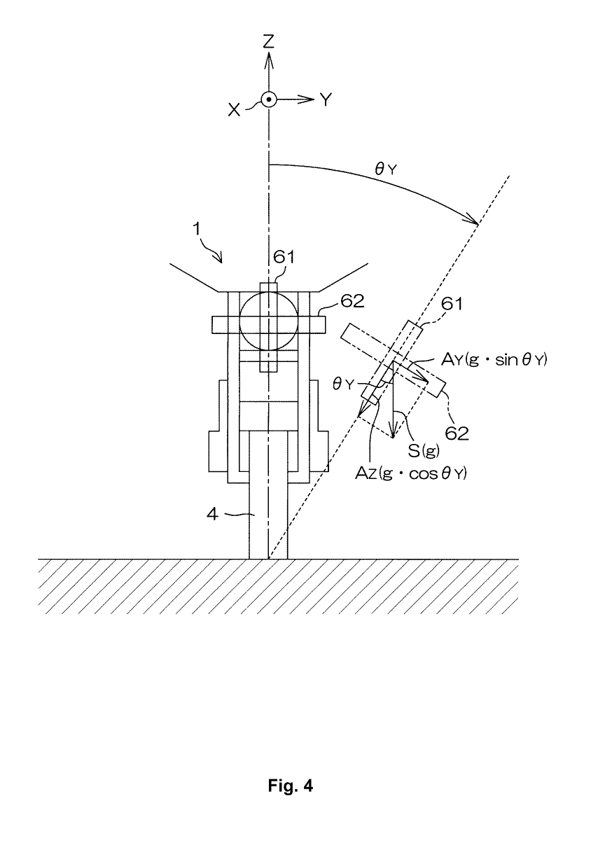

FIG. 4 schematically shows the acceleration detection directions of the vertical acceleration sensor 61 and the lateral acceleration sensor 62, and an inclination angle θ_{Y} of the motorcycle 1 in the lateral direction of the motorcycle 1.

A detection direction of the vertical acceleration sensor 61 with respect to the motorcycle 1 is determined such that acceleration in the gravity direction is detected when the motorcycle 1 is in a non-inclined state. The non-inclined state is a state where the motorcycle 1 is placed on a horizontal surface, there is no difference in height between a ground-contact point of the front wheel 4 and a ground-contact point of the rear wheel 5, and both the front wheel 4 and rear wheel 5 are perpendicular to the horizontal surface. A vertical direction of the motorcycle 1 in the non-inclined state is called “vertical direction”, and a coordinate axis extending along the vertical direction is defined as the “Z axis”. When the motorcycle 1 is in the inclined state, the vertical direction (Z axis) of the motorcycle 1 is inclined from the horizontal plane in accordance with the inclination angle. The acceleration (vertical acceleration) in the vertical direction is detected by the vertical acceleration sensor 61.

A detection direction of the lateral acceleration sensor 62 with respect to the vehicle is determined such that acceleration (lateral acceleration) in the horizontal direction (lateral direction) intersecting with the vertical direction of the vehicle body at right angles is detected when the motorcycle 1 is in the non-inclined state. In the following description, the lateral direction of the motorcycle 1 in the non-inclined state is called “lateral direction”, and a coordinate axis along the lateral direction is defined as “Y axis”. Therefore, when the motorcycle 1 is in the inclined state, the lateral direction (Y axis) of the motorcycle 1 is inclined from the horizontal plane in accordance with the inclination angle. The acceleration in the lateral direction is detected by the lateral acceleration sensor 62.

The longitudinal direction of the motorcycle 1 in the non-inclined state is called a “longitudinal direction”, and a coordinate axis along the longitudinal direction is defined as “X axis”. Therefore, if the motorcycle 1 is inclined in the longitudinal direction, i.e., there is a difference in height between the ground-contact points of the front wheel 4 and the rear wheel 5, respectively, the longitudinal direction (X axis) of the motorcycle 1 is inclined with respect to the horizontal plane in accordance with the inclination angle.

Further, an inclination angle of the Z axis with respect to a vertical plane (plane perpendicular to the horizontal plane) including a traveling direction of the motorcycle 1 is called an “inclination angle in the lateral direction”. The inclination angle in the lateral direction is an inclination angle of the Y axis with respect to the horizontal plane and thus, this inclination angle is designated with a symbol θ_{Y}. A positive symbol is allocated to an inclination angle in the right direction with respect to the inclination angle θ_{Y} in the lateral direction, and a negative symbol is allocated to an inclination angle in the left direction. The inclination angle θ_{Y} is in a range of −180°≦θ_{Y}≦+180°.

An inclination angle of the X axis with respect to the horizontal plane is called “inclination angle in the longitudinal direction”, and is designated with a symbol θ_{X}. The inclination angle in the longitudinal direction θ_{X} in which the front wheel 4 becomes higher than the rear wheel 5 is designated with a positive symbol, and an inclination angle in a direction in which the rear wheel 5 becomes higher than the front wheel 4 is designated with a negative symbol. The inclination angle θ_{X} is in a range of −180°≦θ_{X}≦+180°.

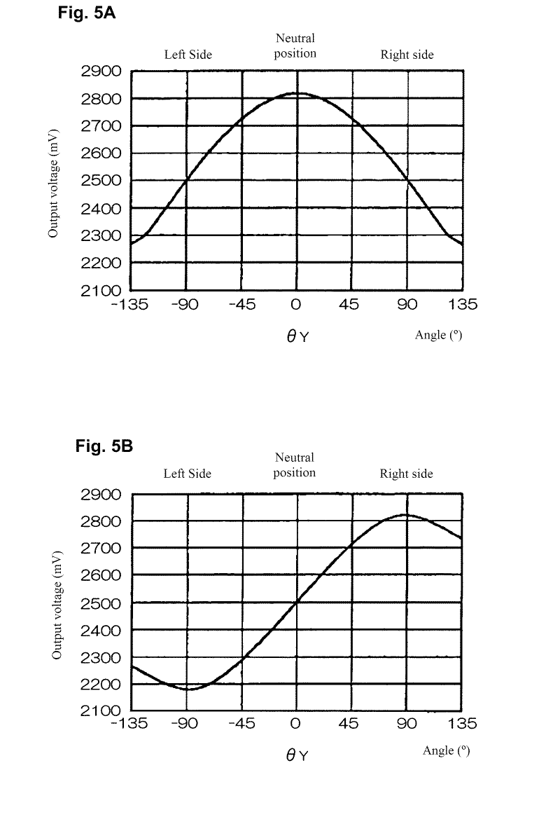

FIG. 5A is a diagram showing a relationship between the inclination angle in the lateral direction θ_{Y} and output voltage of the vertical acceleration sensor 61. FIG. 5B is a diagram showing a relationship between the inclination angle in the lateral direction θ_{Y} and output voltage of the lateral acceleration sensor 62. The output voltage when the inclination angle in the longitudinal direction θ_{X} is zero is shown. For each of the vertical acceleration sensor 61 and the lateral acceleration sensor 62, the output voltage at which zero acceleration is detected is 2500 mV.

The vertical acceleration sensor 61 detects a force component g·cos θ_{Y} in the Z axis direction of the gravity acceleration g as a vertical acceleration (acceleration in the Z axis direction) A_{Z} in accordance with the inclination angle (in the lateral direction) θ_{Y}. Therefore, the output voltage curve of the vertical acceleration sensor 61 has a local maximum point (maximum value, corresponding to A_{Z}=1g) at θ_{Y}=0°, inflection points at θ_{Y}=±90° (corresponding to A_{Z}=0), and local minimum points at θ_{Y}=±180° (minimum values, corresponding to A_{Z}=−1g).

The lateral acceleration sensor 62 detects a force component g·sin θ_{Y} in the Y axis direction of the gravity acceleration g as a lateral acceleration (acceleration in the Y axis direction) A_{Y} in accordance with the inclination angle θ_{Y}. Therefore, the output voltage curve of the lateral acceleration sensor 62 has an inflection point (corresponding to A_{Y}=0) at θ_{Y}=0°, a local maximum point at θ_{Y}=90° (maximum value, corresponding to A_{Y}=1g), and a local minimum point at θ_{Y}=−90° (minimum value, corresponding to A_{Y}=−1g).

The inclination angle calculating module 71 obtains inclination angle θ_{Y}(=tan⁻¹(A_{Y}/A_{Z})) using vertical acceleration A_{Z}(=g·cos θ_{Y}) detected by the vertical acceleration sensor 61 and lateral acceleration A_{Y}(=g·sin θ_{Y}) detected by the lateral acceleration sensor 62. More specifically, in this embodiment, the inclination angle calculating module 71 obtains the ratio of A_{Y}/A_{Z}(=tan θ_{Y}) as a value corresponding to the inclination angle θ_{Y}. If desired, the inclination angle calculating module 71 may then obtain inclination angle θ_{Y} from the inverse tangent of the ratio of A_{Y}/A_{Z}.

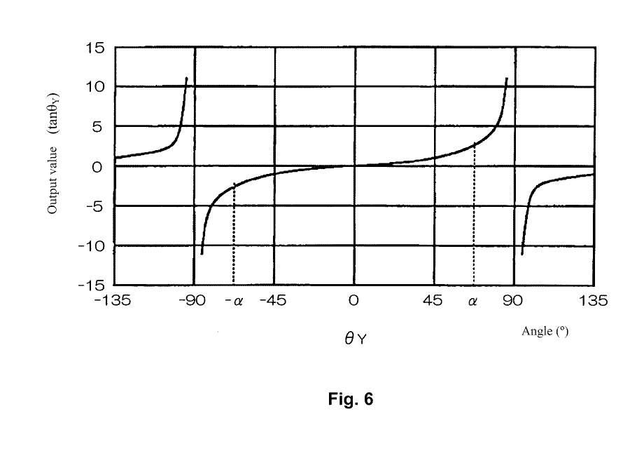

As shown in FIG. 6, when θ_{Y}=+90°, A_{Y}/A_{Z}(=tan θ_{Y}) has an absolute value of infinity. It therefore suffices if the inclination angle in the lateral direction θ_{Y} can be detected in a range of −90°<θ_{Y}<+90° and thus, divergence of the output value at θ_{Y}=+90° may be avoided.

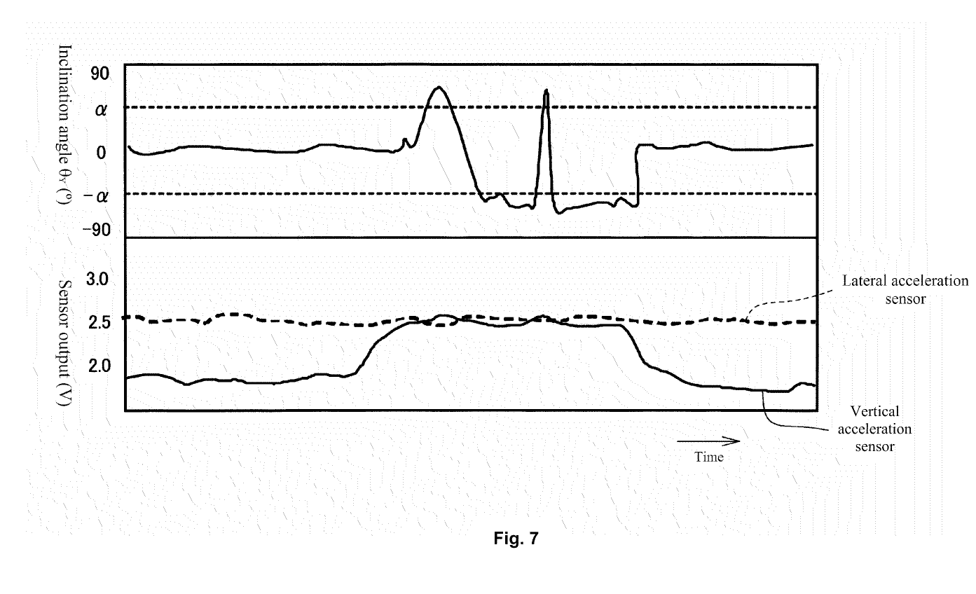

FIG. 7 is a diagram showing a result (upper line) of calculation of the inclination angle θ_{Y} when the motorcycle 1 runs on a bumpy road, and output voltage waveform (lower line) of the vertical acceleration sensor 61 and the lateral acceleration sensor 62. When the motorcycle 1 runs on a bumpy road, the vertical acceleration detected by the vertical acceleration sensor 61 is largely varied.

When shifting from an acclivity portion to a declivity portion, the motorcycle 1 is brought into a gravity-free state or a state close to the gravity-free state. At that time, even if the motorcycle 1 is not inclined in the lateral direction, gravity acceleration (force component in the Z axis direction) detected by the vertical acceleration sensor 61 is very small. Thus, the noise component caused by vibration of the engine 3 or vehicle body becomes predominant in the output voltage of the vertical acceleration sensor 61. Thus, the calculated inclination angle θ_{Y} varies a lot. Therefore, the precision of the inclination angle θ_{Y} is deteriorated during running on a bumpy road.

Another case where the vertical acceleration detected by the vertical acceleration sensor 61 becomes very small is when the absolute value of the inclination angle in the longitudinal direction θ_{X} of the motorcycle 1 is large. Examples of such states include a state where the front wheel 4 is lifted much higher than the rear wheel 5 during running on the acclivity portion, and a state where the rear wheel 5 is lifted much higher than the front wheel 4 during running on the declivity portion. In this case, the vertical direction (Z axis) which is the acceleration detection direction of the vertical acceleration sensor 61 is close to the horizontal plane. Thus, the force component in the vertical direction of the gravity acceleration has become very small. Therefore, the noise component caused by vibration of the engine 3 becomes predominant in the output voltage of the vertical acceleration sensor 61, and the calculated inclination angle θ_{Y} varies a lot. Thus, the precision of calculating the inclination angle θ_{Y} is deteriorated.

Like a case where the motorcycle 1 runs on a bumpy road, when the vehicle body is brought into the gravity-free state or the absolute value of the inclination angle in the longitudinal direction θ_{X} of the vehicle body is large, the vertical acceleration A_{Z} becomes very small. In such case, the calculation of the inclination angle θ_{Y} was largely varied with slight variation of the output from the lateral acceleration sensor 62, i.e., the actual inclination angle and the calculated inclination angle were different from each other. Further, the inventor has discovered that in such a running scene, where the inclination angle θ_{Y} in the lateral direction of the vehicle body is not actually large, calculation of the inclination angle θ_{Y} might be canceled.

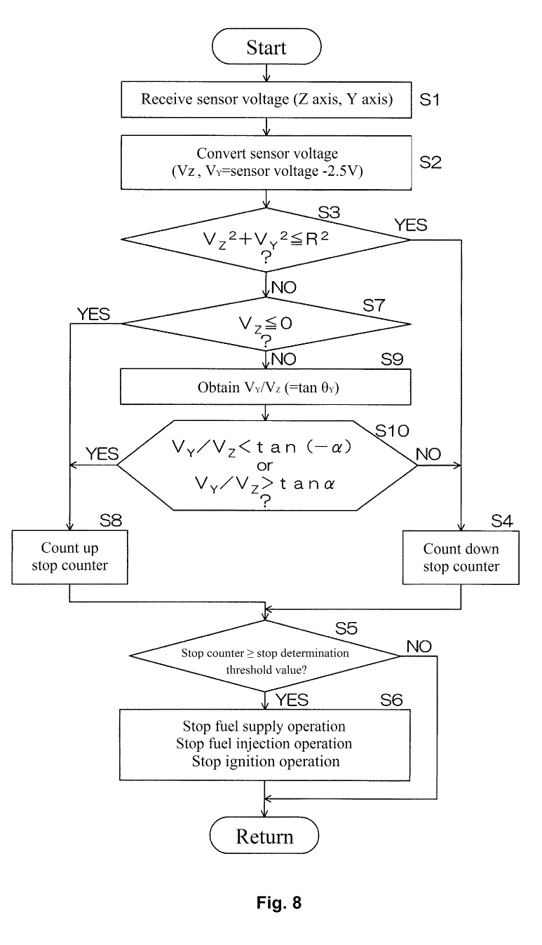

FIG. 8 is a flowchart illustrating the control operation which is executed by the ECU 50 based on output signals of the vertical acceleration sensor 61 and the lateral acceleration sensor 62. The ECU 50 repeatedly executes this control operation during operation of the engine 3 at a predetermined control cycle (e.g., 5 msec). Here, the expression “during operation of the engine 3” means during fuel supply operation carried out by the fuel pump 47, during fuel injection operation carried out by the fuel injector 40, and during ignition operation carried out by the ignition coil 45.

First, the ECU 50 receives the output voltage of the vertical acceleration sensor 61 and the output voltage of the lateral acceleration sensor 62 (step S1). Next, the ECU 50 converts the received output sensor voltages into voltage values corresponding to a cosine signal and a sine signal (step S2). More specifically, Z axis output voltage V_{Z} and Y axis output voltage V_{Y} are obtained by subtracting output voltage when the acceleration is zero (0g voltage, e.g., 2.5V in the present embodiment, see FIGS. 5A and 5B) from the received output voltage. The Z axis output voltage V_{Z} is proportional to the vertical acceleration A_{Z}, and the Y axis output voltage V_{Y} is proportional to the lateral acceleration A_{Y}.

Next, it is determined whether a sensor output absolute value is equal to or lower than a predetermined value R (error detection condition) by operation of the calculation cancelling module 72 using the Z axis output voltage V_{Z} and Y axis output voltage V_{Y} (step S3). More specifically, it is determined whether V_{Z}²+V_{Y}²≦R² is established, i.e., whether √(V_{Z}²+V_{Y}²)≦R. If the sensor output absolute value is small and a result of this determination is YES, the ECU 50 omits the calculation step (step S9) concerning the inclination angle θ_{Y} by operation of the calculation cancelling module 72, and cancels the calculation of the inclination angle θ_{Y}. The ECU 50 counts down (e.g., −100) the stop counter for controlling the stopping of the engine 3 by the operation of the inclination angle determining module 73 (step S4). The inclination angle determining module 73 determines whether the stop counter has reached a stop determination threshold value (step S5). A case where a result of this determination is YES is when a state in which the inclination angle θ_{Y} of the motorcycle 1 in the lateral direction continues to be large and thus the motorcycle 1 is inclined.

If the value of the stop counter reaches the stop determination threshold value (step S5: YES), the ECU 50 stops the fuel supply operation by the fuel pump 47 by operation of the fuel supply control module 78 (step S6). The ECU 50 also stops the fuel injection operation by the fuel injector 40 by operation of the fuel injection control module 76 (step S6). Further, the ECU 50 stops the ignition operation by the ignition coil 45 by operation of the ignition control module 77 (step S6). With this setup, the engine 3 is stopped.

If the value of the stop counter does not reach the stop determination threshold value (step S5: NO), the engine stop control (step S6) is not carried out, i.e. the fuel supply operation by the fuel pump 47, the fuel injection operation by the fuel injector 40 and the ignition operation by the ignition coil 45 are continued.

If the sensor output absolute value is large and a result of determination in step S3 is NO, the ECU 50 determines whether the Z axis output voltage V_{Z} is equal to or lower than 0 (step S7), i.e., whether vertical acceleration A_{Z} detected by the vertical acceleration sensor 61 by the operation of the inclination angle calculating module 71 is equal to or lower than 0. That is, it is determined whether the upward and downward directions of the motorcycle 1 are reversed. If a result of this determination is YES, the stop counter is counted up (e.g., +1) (step S8). Then, the procedure from step S5 is carried out.

It is preferable that the count up width of the stop counter is smaller than a count down width. With this setup, when the inclination angle θ_{Y} in the lateral direction of the motorcycle 1 becomes large temporarily, the engine 3 is not stopped. On the other hand, when a state where the inclination angle θ_{Y} is large is continued and the stop counter reaches the stop determination threshold value (continuation condition), the engine 3 can be stopped.

If it is determined in step S7 that the vertical acceleration A_{Z} detected by the vertical acceleration sensor 61 is greater than 0, the inclination angle calculating module 71 obtains a value corresponding to the inclination angle θ_{Y} in the lateral direction. More specifically, the inclination angle calculating module 71 obtains a ratio V_{Y}/V_{Z}(=A_{Y}/A_{Z}=tan θ_{Y}) between the Z axis output voltage V_{Z} and Y axis output voltage V_{Y} (step S9). Moreover, using this ratio V_{Y}/V_{Z}, it is determined whether the inclination angle absolute value |θ_{Y}| in the lateral direction is greater than a predetermined threshold value α (α is a positive constant, i.e., α=70°) by the operation of the inclination angle determining module 73 (step S10). More specifically, the ratio V_{Y}/V_{Z} is compared with the threshold value tan α and tan (−α). In other words, it is determined whether V_{Y}/V_{Z}<tan (−α) or V_{Y}/V_{Z}>tan α is established. That is, it is determined whether |V_{Y}/V_{Z}|>tan α is established.

When a result of this determination is YES, this means that the absolute value |θ_{Y}| of the inclination angle exceeds the threshold value α, the stop counter is counted up (step S8). If the result of the determination in step S10 is NO, the stop counter is counted down (step S4).

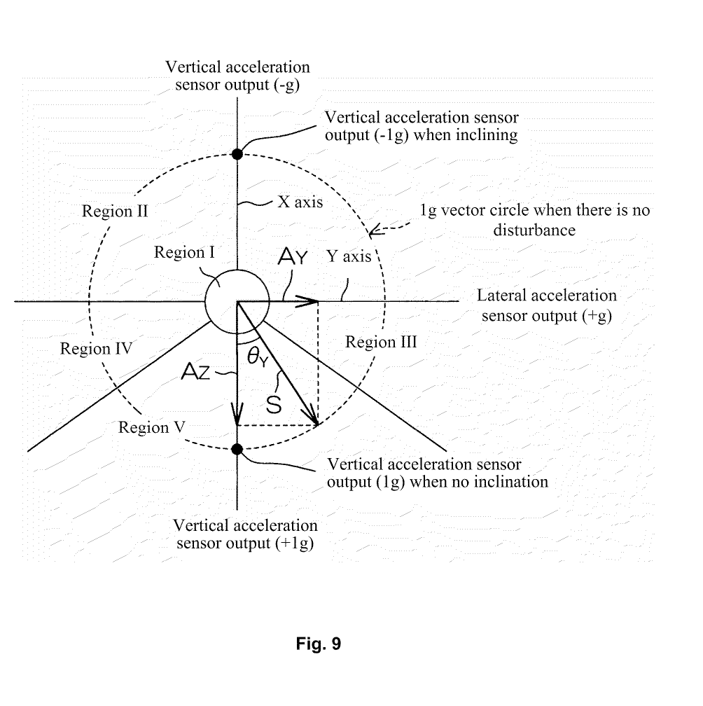

FIG. 9 graphically shows a determination carried out by the ECU 50 concerning the inclination angle in the lateral direction θ_{Y}. A coordinate plane in which vertical acceleration A_{Z} detected by the vertical acceleration sensor 61 is indicated on the vertical axis (first coordinate axis), and lateral acceleration A_{Y} detected by the lateral acceleration sensor 62 is indicated on the lateral axis (second coordinate axis) is conceived. In the coordinate plane, the vertical acceleration A_{Z} is expressed with a vector in which an original point is a start point, and an end point corresponding to the value that exists on a coordinate axis (Z axis) of the vertical acceleration. Similarly, the lateral acceleration A_{Y} is expressed with a vector in which an original point is a start point, and an end point corresponds to the value that exists on a coordinate axis (Y axis) of the lateral acceleration. A synthesis vector S of the vertical acceleration vector (A_{Z}) and a lateral acceleration vector (A_{Y}) is also shown. When the inclination angle θ_{X} in the longitudinal direction is 0, the synthesis vector S becomes a vector expressing gravity acceleration g (see FIG. 4). An angle formed by the synthesis vector S with respect to the coordinate axis (Z axis) of the vertical acceleration is equal to the inclination angle θ_{Y} of the motorcycle 1 (see also FIG. 4).

The synthesis vector S can be expressed by component indication (A_{Y}, A_{Z}) using Y component A_{Y} (lateral acceleration) and Z component A_{Z} (vertical acceleration) by coordinate of its end point. A region I of A_{Y}²+A_{Z}²≦r² in a YZ plane is a circular region having a radius r including the original point. This region I is a minute output region where output signals of the acceleration sensors 61 and 62 are very small. In step S3 in FIG. 8, it is determined whether the end point of the synthesis vector S belongs to the minute output region I. The radius r is a value which is proportional to the predetermined value R, and r is set to about 0.1g for example.

On the other hand, out of the minute output region I, a region II of A_{Z}≦0 is a region where the inclination angle θ_{Y} is in a range of 90°≦θ_{Y}≦180° and −90°≧θ_{Y}≧−180°. In this region II, the attitude of the motorcycle 1 is vertically reversed. In step S7 in FIG. 8, it is determined whether the end point of the synthesis vector S belongs to the region II.

Outside the minute output region I, in a region of A_{Z}>0, the determination in step S10 in FIG. 8 is made. This region is divided into a region III of α<θ_{Y} and a region IV of θ_{Y}<−α, and a region V of α≧θ_{Y}≧−α. If the end point of the synthesis vector S belong to a region V, the inclination angle θ_{Y} in the lateral direction of the motorcycle 1 falls in a normal range, and it is unnecessary to carry out the stop control of the engine 3. When the end point of the synthesis vector S belongs to the region III or the region IV, the inclination angle θ_{Y} in the lateral direction exceeds the normal range. In this case, the stop counter is counted up toward the stop control of the engine 3. In step S10 in FIG. 8, it is determined whether the synthesis vector S belongs to regions III, IV and V.

According to this embodiment, it is determined whether the vertical acceleration A_{Z} and the lateral acceleration A_{Y} respectively detected by the vertical acceleration sensor 61 and the lateral acceleration sensor 62 satisfy predetermined error detection condition (step S3 in FIG. 8). When the error detection condition is satisfied, the calculation of the inclination angle θ_{Y} (in this embodiment, calculation of V_{Y}/V_{Z}) is canceled (step S3 in FIG. 8: YES). With this setup, when the calculation of the inclination angle θ_{Y} becomes unstable, since the calculation can be canceled, a difference between the actual inclination angle and the calculated inclination angle can be suppressed, and the inclination angle can stably be detected. As a result, useless control based on the unstable calculation result can be suppressed.

In this embodiment, when the error detection condition is satisfied, calculation of V_{Y}/V_{Z} corresponding to the inclination angle θ_{Y} is not carried out, and outputs of the vertical acceleration sensor 61 and the lateral acceleration sensor 62 are canceled. With this setup, the inclination angle calculation is canceled.

In this embodiment, the error detection condition (step S3 in FIG. 8) corresponds to the vertical acceleration and the lateral acceleration which are respectively detected by the vertical acceleration sensor 61 and the lateral acceleration sensor 62 when the motorcycle 1 is brought into the gravity-free state. This error detection condition also corresponds to the vertical acceleration and the lateral acceleration which are detected in a state where the inclination angle in the longitudinal direction θ_{X} of the motorcycle 1 is greater than an inclination angle threshold value β (e.g., β=70°) in the predetermined longitudinal direction.

Therefore, in a state where the motorcycle 1 runs on a bumpy road, calculation of inclination angle θ_{Y} having large error can be suppressed or avoided. That is, when the motorcycle 1 is brought into the gravity-free state or when the motorcycle 1 is largely inclined in the longitudinal direction, calculation of the inclination angle θ_{Y} having a large error can be suppressed or avoided. With this setup, power source control (stop control) of the engine 3 based on the inclination angle θ_{Y} can be carried out excellently.

In this embodiment, in the coordinate plane in which the vertical acceleration is indicated on the first coordinate axis and the lateral acceleration is indicated on the second coordinate axis, the minute output region I including the coordinate origin is set. The error detection condition implies that a coordinate point expressed by the pair of vertical acceleration and lateral acceleration respectively detected by the vertical acceleration sensor 61 and the lateral acceleration sensor 62 belong to the minute output region I. That is, when the magnitude of the synthesis vector S of the vertical acceleration vector and the lateral acceleration vector is small, error is prone to be generated in the inclination angle calculation. Hence, the inclination angle calculation is canceled in such a condition. With this setup, a difference between the actual inclination angle and the calculated inclination angle is suppressed, and the inclination angle can stably be calculated. As a result, the stop control of the engine 3 can be carried out excellently.

In this embodiment, the minute output region I is a circular region having a radius r including the coordinate origin of the coordinate plane. With this setup, when the magnitude of the synthesis vector S is small, the inclination angle calculation can be canceled.

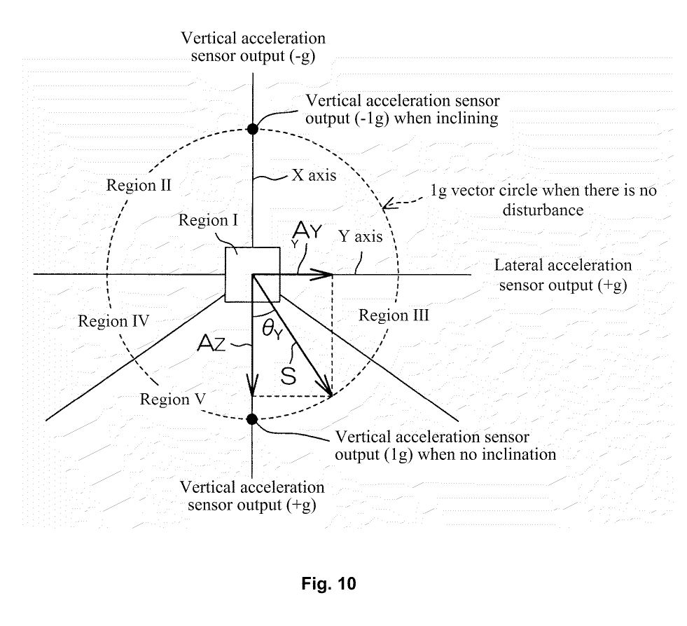

FIG. 10 graphically shows another setting example of the minute output region I. Although the circular minute output region I including the original point on the YZ plane is set in the previous embodiment, a rectangular (square in FIG. 10) minute output region I around the original point is set in the example shown in FIG. 10. That is, the minute output region I can be expressed as |A_{Z}|≦T_{Z}, and |A_{Y}|≦T_{Y} (wherein, T_{Z} and T_{Y} are positive constants), and when this condition is established, it is determined that the detection precision of the inclination angle θ_{Y} has deteriorated. That is, it should be determined whether the conditions |A_{Z}|≦T_{Z} and |A_{Y}|≦T_{Y} are satisfied instead of the determination in step S3 in FIG. 8. With this setup, it becomes easy to determine the error detection condition.

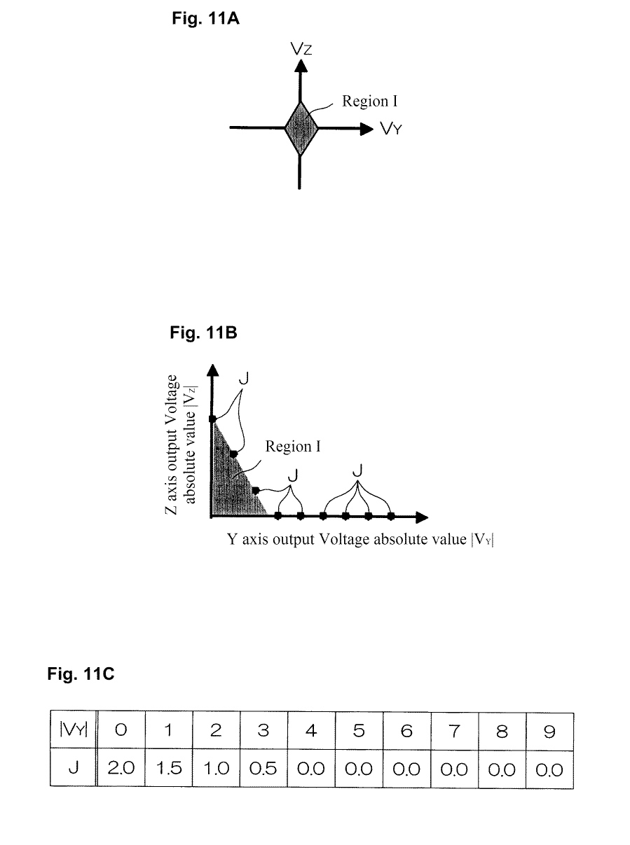

FIG. 11A graphically shows another setting example of the minute output region I. In this example, a rhombus minute output region I is set in which two diagonal lines are superposed on a coordinate axis (Y axis) in the lateral acceleration and the coordinate axis (Z axis) in the vertical acceleration. That is, the minute output region I is surrounded by four straight lines expressed by V_{Z}=−a·V_{Y}+b, V_{z}=a·V_{Y}+b, V_{Z}=−a·V_{Y}−b, V_{Z}=a·V_{Y}−b (wherein, a and b are positive constants). The determination in step S3 in FIG. 8 may be replaced by determination whether the end point of the synthesis vector S belongs to the rhombus minute output region I.

More specifically, as shown in FIGS. 11B and 11C, a region determination value map is prepared in which a region determination value J (J≧0) is associated with various absolute values (corresponding to absolute value |A_{Y}| of the lateral acceleration) of the Y axis output voltage V_{Y}. This region determination value map is preferably previously stored in a memory module (not shown) provided in the ECU 50. The region determination value J is determined such that J=−a·|V_{Y}|+b in a region 0≦|V_{Y}<b/a, and |V_{Z}|=0 in a region b/a≦|V_{Y}|. The ECU 50 searches the region determination value map using the absolute value |V_{Y}| of the Y axis output voltage, and reads a corresponding region determination value J(V_{Y}). Moreover, the ECU 50 compares the absolute value |V_{Z}| of the Z axis output voltage and the region determination value J(V_{Y}). If |V_{Z}|>J(V_{Y}), the ECU 50 determines that the end point of the synthesis vector S does not belong to the minute output region I. If |V_{Z}|≦J(V_{Y}), the ECU 50 determines that the end point of the synthesis vector S belongs to the minute output region I. This determining technique can also be applied when the minute output region I is circular (FIG. 9), rectangular (FIG. 10) and other shape(s) as needed.

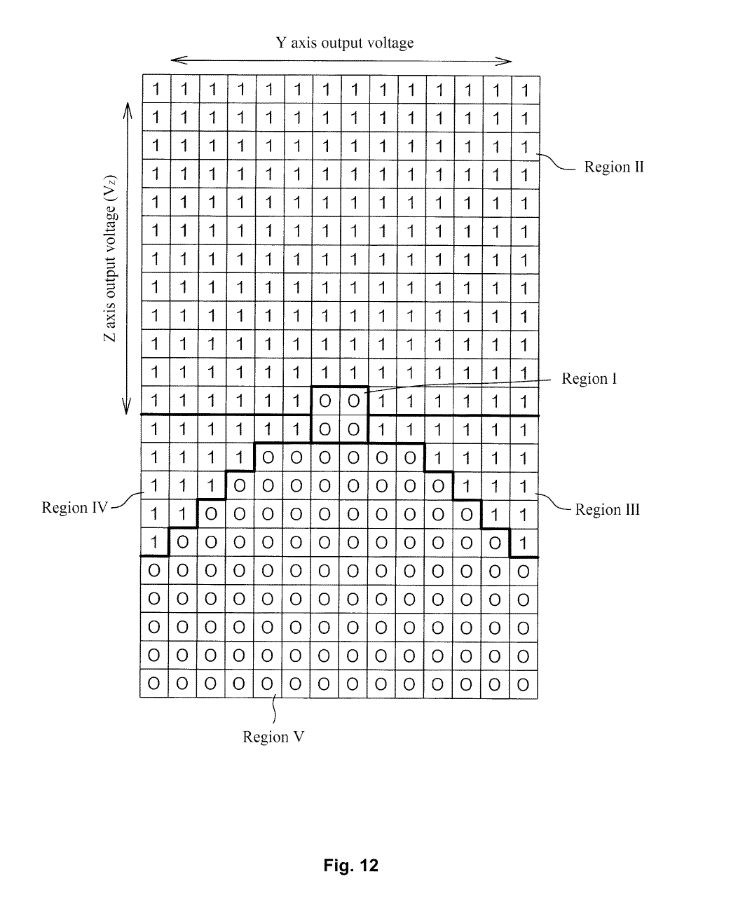

FIG. 12 is a diagram illustrating region determination by a map. In this example, a determination map in which stop flags with respect to various combinations of the Y axis output voltage V_{Y} and Z axis output voltage V_{Z} is previously stored in the memory module (not shown) in the ECU 50. A stop flag “1” means that the stop counter should be counted up, and a stop flag “0” means that the stop counter should be counted down. The stop flag “0” is allocated to a set of the output voltage V_{Y} and V_{Z} corresponding to the region I (rectangular region including the original point in this example) and the region V. The stop flag “1” is allocated to a set of the output voltage V_{Y} and V_{Z} corresponding to the regions II, III and IV.

The determinations in steps S3, S7 and S10 shown in FIG. 8 can be replaced by determination processing using the region determination map shown in FIG. 12. The ECU 50 checks the received output voltage V_{Y} and V_{Z} against the region determination map, and reads a corresponding stop flag. If the read stop flag is “1”, the ECU 50 counts up the stop counter (step S8). If the stop flag is “0”, the ECU 50 counts down the stop counter (step S4).

In this case, an angle region of the inclination angle θ_{Y} is divided into 90°≦θ_{Y}<180° and −180°≦θ_{Y}<−90° (region II), −90°<θ_{Y}<−α (region III), α<θ_{Y}<90° (region IV) and −α≦θ_{Y}≦α (region V). The inclination angle calculating module 71 and the inclination angle determining module 73 calculate an angle region to which the inclination angle θ_{Y} belongs (inclination angle calculation). This inclination angle calculation is cancelled when the set of output voltage V_{Y} and V_{Z} belong to the minute output region I (rectangular region in the example shown in FIG. 12). The same determination technique can also be applied when the minute output region I is circular (FIG. 9), rhombus (FIG. 11A) and other suitable shape(s).

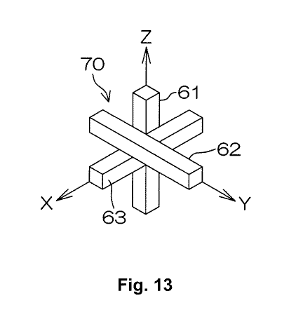

FIG. 13 graphically shows a second embodiment of the invention, and more specifically shows a structure of an acceleration sensor unit 70 which can be used instead of the acceleration sensor unit 60. The acceleration sensor unit 70 is a so-called triaxial sensor unit, and includes a back-and-forth acceleration sensor 63 in addition to the vertical acceleration sensor 61 and the lateral acceleration sensor 62 (see also FIG. 3). A detection direction of the back-and-forth acceleration sensor 63 is determined such that when the motorcycle 1 is in the non-inclined state, the back-and-forth acceleration sensor 63 detects acceleration (back-and-forth acceleration ) in the longitudinal direction (X axis direction) of the motorcycle 1.

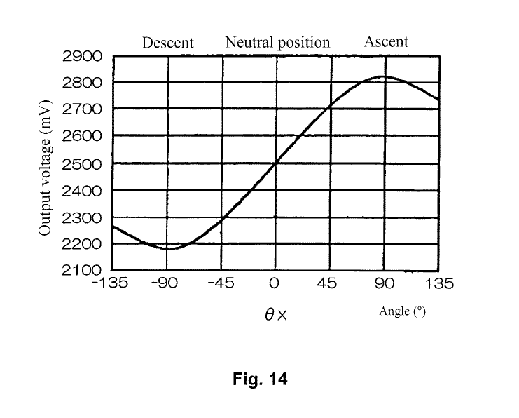

FIG. 14 is a graph showing the output characteristics of the back-and-forth acceleration sensor 63. The back-and-forth acceleration sensor 63 detects a force component g·sin θ_{X} in the longitudinal direction of the gravity acceleration g as back-and-forth acceleration (X axis direction acceleration) A_{X} in accordance with the inclination angle θ_{X} in the longitudinal direction. Therefore, the output voltage curve of the back-and-forth acceleration sensor 63 has an inflection point (A_{X}=0) when θ_{X}=0°, and has a local maximum point (maximum value, A_{X}=−g) when θ_{X}=90°, and has local minimum point (minimum value, A_{X}=1g) when θ_{X}=−90°.

With this arrangement, the ECU 50 can distinguish a case where the motorcycle 1 is in the gravity-free state and a case where the inclination angle θ_{X} in the longitudinal direction of the motorcycle 1 is large using the back-and-forth acceleration A_{X} in addition to the vertical acceleration A_{Z} and lateral acceleration A_{Y}. Based on the determination result, the ECU 50 appropriately carries out engine stop control based on the inclination angle θ_{Y} in the lateral direction.

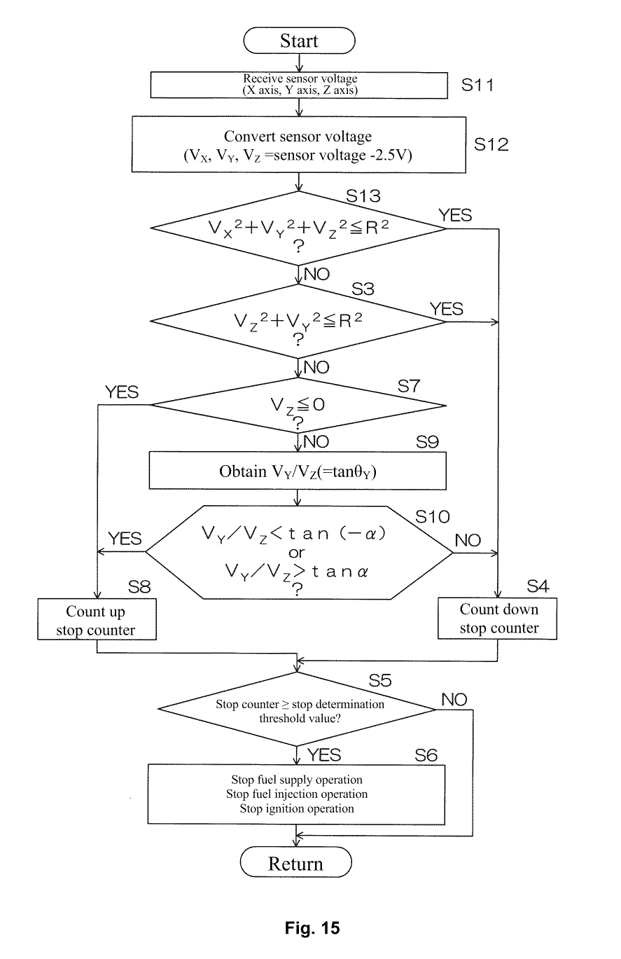

FIG. 15 is a flowchart depicting control operation which is executed based on output signals of the vertical acceleration sensor 61, the lateral acceleration sensor 62 and the back-and-forth acceleration sensor 63. The ECU 50 repeatedly executes this operation at a predetermined control cycle (e.g., 5 msec) during operation of the engine 3. In FIG. 15, steps where the same processing by ECU 50 is carried out as that of the steps shown in FIG. 8 are designated with the same symbols.

First, the ECU 50 receives output voltages from the vertical acceleration sensor 61, the lateral acceleration sensor 62 and the back-and-forth acceleration sensor 63 (step S11). Next, the ECU 50 converts the received output voltages into voltage values corresponding to a cosine signal and a sine signal (step S12). More specifically, X axis output voltage V_{X}, Y axis output voltage V_{Y}, and Z axis output voltage V_{Z} are obtained by subtracting output voltage when the acceleration is zero (0g voltage, e.g., 2.5V, see FIGS. 5A, 5B, and 14) from the received output voltage. The X axis output voltage V_{X} is proportional to the back-and-forth acceleration A_{X}, the Y axis output voltage V_{Y} is proportional to the lateral acceleration A_{Y}, and the Z axis output voltage V_{Z} is proportional to the vertical acceleration A_{Z}.

Next, it is determined whether a sensor output absolute value is equal to or lower than a predetermined value R (error detection condition) by operation of the calculation cancelling module 72 using the X axis output voltage V_{X}, Y axis output voltage V_{Y}, and Z axis output voltage V_{Z} (step S13). More specifically, it is determined whether V_{X}²+V_{Y}²+V_{Z}²≦R² is established, i.e., whether √(V_{X}²+V_{Y}²+V_{Z}²)≦R. If the sensor output absolute value is small and a result of this determination is YES, the ECU 50 omits the calculation step (step S9) concerning the inclination angle θ_{Y} by operation of the calculation cancelling module 72, and cancels the calculation of the inclination angle θ_{Y}. The ECU 50 counts down (e.g., −100) the stop counter for controlling stop of the engine 3 by the operation of the inclination angle determining module 73 (step S4). The inclination angle determining module 73 determines whether the stop counter reaches a stop determination threshold value (step S5). A case where a result of this determination is YES is when a state in which the inclination angle θ_{Y} of the motorcycle 1 in the lateral direction continues to be large and thus the motorcycle 1 is inclined.

If the value of the stop counter reaches the stop determination threshold value (step S5: YES), the ECU 50 stops the fuel supply operation by the fuel pump 47 by operation of the fuel supply control module 78 (step S6). The ECU 50 also stops the fuel injection operation by the fuel injector 40 by operation of the fuel injection control module 76 (step S6). Further, the ECU 50 stops the ignition operation by the ignition coil 45 by operation of the ignition control module 77 (step S6). With this setup, the engine 3 is stopped.

If the value of the stop counter does not reach the stop determination threshold value (step S5: NO), the engine stop control (step S6) is not carried out, i.e. the fuel supply operation by the fuel pump 47, the fuel injection operation by the fuel injector 40, and the ignition operation by the ignition coil 45 are continued.

If the sensor output absolute value is large and a result of determination in step S13 is NO, then the ECU 50 determines whether Z axis and Y axis sensor output absolute values are equal to or lower than a predetermined value R using the Z axis output voltage V_{Z} and Y axis output voltage V_{Y} by the operation of the calculation cancelling module 72 (step S3). More specifically, it is determined whether V_{Z}²+V_{Y}²≦R², i.e., if √(V_{Z}²+V_{Z}²)≦R is established. When the Z axis and Y axis sensor output absolute values are small and a result of this determination is YES, it can be determined that the motorcycle 1 is largely inclined in the longitudinal direction, the back-and-forth acceleration A_{X} is large, and the calculation of the inclination angle θ_{Y} becomes unstable. In this case, the ECU 50 counts down the stop counter for stop control of the engine 3 by operation of the inclination angle determining module 73 (step S4).

If the Z axis and Y axis sensor output absolute values are large and a result of determination in step S3 is NO, the ECU 50 determines whether the Z axis output voltage V_{Z} is equal to or lower than 0 (step S7), i.e., whether vertical acceleration A_{Z} detected by the vertical acceleration sensor 61 by the operation of the inclination angle calculating module 71 is equal to or lower than 0. That is, it is determined whether upward and downward directions of the motorcycle 1 are reversed. In other words, a determination is made whether the motorcycle 1 is potentially upside down. If a result of this determination is YES, the stop counter is counted up (e.g., +1) (step S8). Then, the procedure from step S5 is carried out.

If it is determined in step S7 that the vertical acceleration A_{Z} detected by the vertical acceleration sensor 61 is greater than 0, the inclination angle calculating module 71 obtains a value corresponding to the inclination angle in the lateral direction θ_{Y}. More specifically, the inclination angle calculating module 71 obtains a ratio V_{Y}/V_{Z}(=A_{Y}/A_{Z}=tan θ_{Y}) between the Z axis output voltage V_{Z} and Y axis output voltage V_{Y} (step S9). Using this ratio V_{Y}/V_{Z}, it is determined whether the inclination angle absolute value |θ_{Y}| in the lateral direction is greater than a predetermined threshold value α(>0) by the operation of the inclination angle determining module 73 (step S10).

When a result of this determination is YES, this means that the absolute value |θ_{Y}| of the inclination angle exceeds the threshold value α, the stop counter is counted up (step S8). If the result of the determination in step S10 is NO, the stop counter is counted down (step S4).

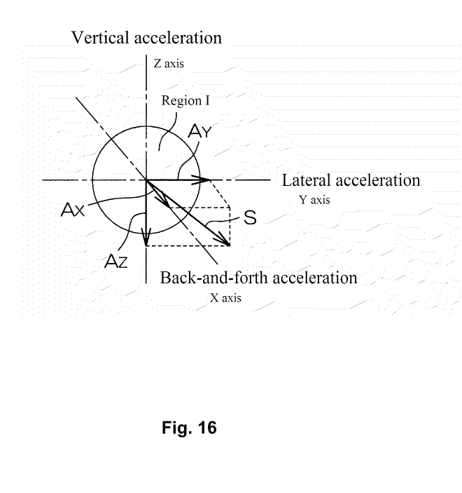

FIG. 16 graphically shows a determination carried out by the ECU 50 concerning step S13 in FIG. 15. A three-dimensional coordinate space is shown in which vertical acceleration A_{Z} detected by the vertical acceleration sensor 61 is indicated on the vertical axis (Z axis: first coordinate axis), lateral acceleration A_{Y} detected by the lateral acceleration sensor 62 is indicated on the lateral axis (Y axis: second coordinate axis), and back-and-forth acceleration A_{X} detected by the back-and-forth acceleration sensor 63 is indicated on a back-and-forth axis (X axis: third coordinate axis) perpendicular to the vertical axis and the lateral axis. In this coordinate space, an original point of the vertical acceleration A_{Z} is a start point, and this is expressed with a vector having an end point corresponding to the value on the Z axis. Similarly, an original point of the lateral acceleration A_{Y} is a start point, and is expressed with a vector having an end point corresponding to the value on the Y axis. An original point of the back-and-forth acceleration A_{X} is a start point, and is expressed with a vector having an end point corresponding to the value on the X axis. A synthesis vector S of the vertical acceleration vector (A_{Z}), lateral acceleration vector (A_{Y}), and back-and-forth acceleration vector (A_{X}) is also shown.

The synthesis vector S can be expressed as (A_{X}, A_{Y} and A_{Z}) using X component A_{X} (back-and-forth acceleration), Y component A_{Y} (lateral acceleration) and Z component A_{Z} (vertical acceleration) based upon the coordinates of the end points. In the XYZ space, a region I of A_{X}²+A_{Y}²+A_{Z}²≦r² is a spherical region having a radius r including an original point. This region I is a minute output region where output signals of the acceleration sensors 61, 62 and 63 are minute. In step S13 in FIG. 15, it is determined whether the end point of the synthesis vector S belongs to the minute output region I.

According to the embodiment, back-and-forth acceleration A_{X} is detected by the back-and-forth acceleration sensor 63 in addition to the vertical acceleration A_{Z} and the lateral acceleration A_{Y}. With this setup, a state where an error is prone to be generated in the inclination angle calculation in the lateral direction of the motorcycle 1 can be detected more precisely.

In this embodiment, a coordinate space is assumed in which the vertical acceleration A_{Z} is indicated on the first coordinate axis (Z axis), the lateral acceleration A_{Y} is indicated on the second coordinate axis (Y axis) and the back-and-forth acceleration A_{X} is indicated on the third coordinate axis (X axis). In this coordinate space, an error detection condition is that a coordinate point expressed with a set of the vertical acceleration A_{Z}, the lateral acceleration A_{Y} and the back-and-forth acceleration A_{X} belongs to a minute output region I including the coordinate origin (step S13 in FIG. 15). That is, when the magnitude of the synthesis vector S of the vertical acceleration vector, the lateral acceleration vector and the back-and-forth acceleration vector is small, an error is prone to be generated in the inclination angle calculation. Thus, in such a condition, the inclination angle calculation is canceled.

In this embodiment, the minute output region I is a spherical region having a radius including the coordinate origin in the coordinate space. With this setup, when the magnitude of the synthesis vector S is small, the inclination angle calculation can be canceled.

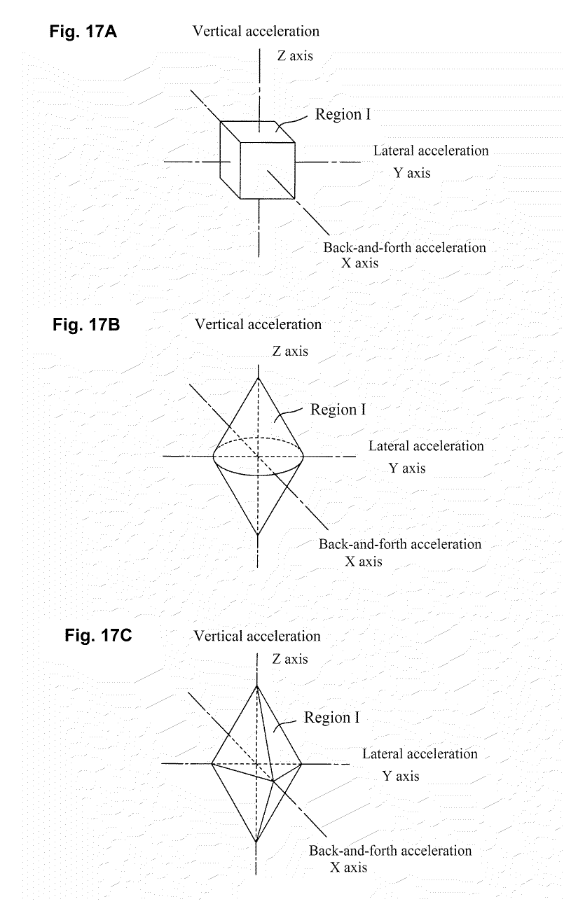

Like the first embodiment, the minute output region I need not be spherical in shape, and may be a region in a rectangular parallelepiped (e.g., a cube) including an original point in the XYZ space as shown in FIG. 17A for example. With this setup, the end point position of the synthesis vector S can easily be determined. As shown in FIG. 17B, the region may be inside a spindle-shaped body obtained by rotating a rhombus region shown in FIG. 11A around the Z axis. As shown in FIG. 17C, the region may be inside a shape (octahedron) obtained by coupling a normal four-sided pyramid and an inverted rectangular spindle having a bottom surface on the XY plane and top on the Z axis.

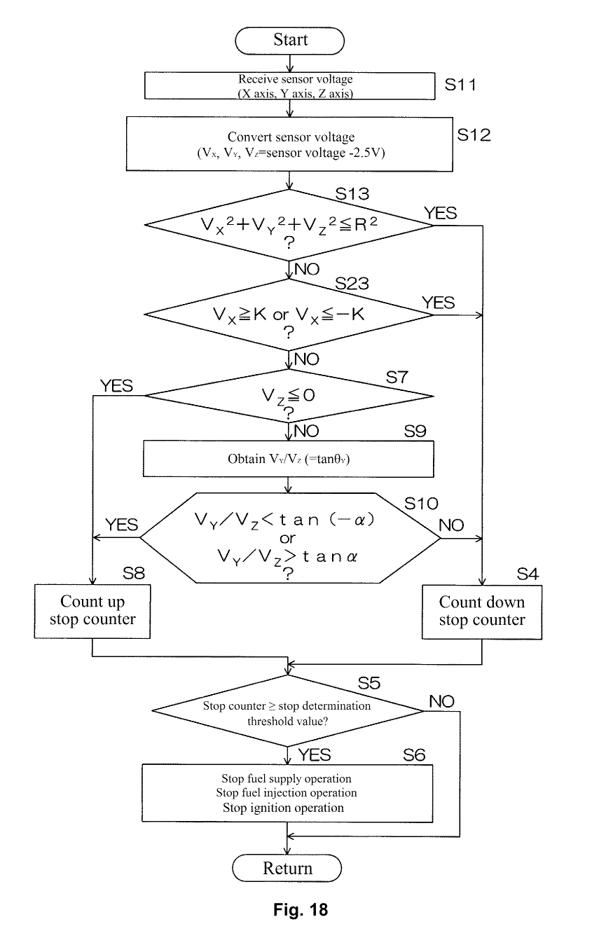

FIG. 18 is a flowchart for explaining a processing example of the ECU 50 which can be applied instead of the processing shown in FIG. 15. In FIG. 18, steps where the same processing is carried out as that of the steps shown in FIG. 15 are designated with the same symbols.

In this processing example, instead of the determination in step S3 in FIG. 15, it is determined whether one of V_{X}≧K or V_{X}≦−K (K is a vertical axis threshold value and K>0) is established for the X axis output voltage V_{X} corresponding to output of the back-and-forth acceleration sensor 63 (step S23). In this step, it is determined whether |A_{X}| of the absolute value of the back-and-forth acceleration is large, i.e., whether the inclination angle θ_{X} in the longitudinal direction is large. When a result of this determination is YES, it is determined that the calculation of the inclination angle θ_{Y} becomes unstable, and the processing step S4 is carried out. If the result of determination in step S23 is NO, the procedure is advanced to step S7.

It is preferable that the back-and-forth acceleration threshold value K is set to a value corresponding to the inclination angle threshold value β in the longitudinal direction. With this setup, in step S23, it is determined whether the absolute value |θ_{X}| of the inclination angle in the longitudinal direction substantially exceeds the inclination angle threshold value β in the longitudinal direction.

The back-and-forth acceleration A_{X} becomes large when the motorcycle 1 largely inclines in the longitudinal direction. In such a state, since the detection direction of the vertical acceleration sensor 61 becomes close to the horizontal direction, it is difficult for the vertical acceleration sensor 61 to detect the gravity acceleration. Therefore, if attempt is made to obtain the inclination angle θ_{Y} in the lateral direction based on a ratio between the lateral acceleration A_{Y} and the vertical acceleration A_{Z}, detection error is prone to become large. Hence, in this embodiment, a condition that the back-and-forth acceleration A_{X} is equal to or greater than the back-and-forth acceleration threshold value K is established for canceling the inclination angle calculation. With this setup, when the motorcycle 1 largely inclines in the longitudinal direction, it is possible to restrain or prevent the inclination angle θ_{Y} from being obtained with a large error.

Although the embodiments of the present invention have been explained above, the invention can also be carried out in another mode. For example, in the above embodiments, the entire region which may be circular (FIG. 9), rectangular (FIG. 10), rhombus (FIG. 11A), spherical (FIG. 16), cube (FIG. 17A), spindle shape (17B) and octahedron (FIG. 17C) is defined as the minute output region I. However, a portion of the region of these shapes may be defined as the minute output region I. In FIGS. 9 and 10 for example, the entire region of A_{Z}≦0 may be defined as a region II, and a region (A_{Z}>0) of the circular or rectangular region lower than the Y axis may be defined as a minute output region I. Only an inclination angle region (region concerning the stop control of the engine 3) corresponding to the regions III and IV of the circular or rectangular region may be defined as a minute output region I. The same can be applied to minute output regions of other shapes.

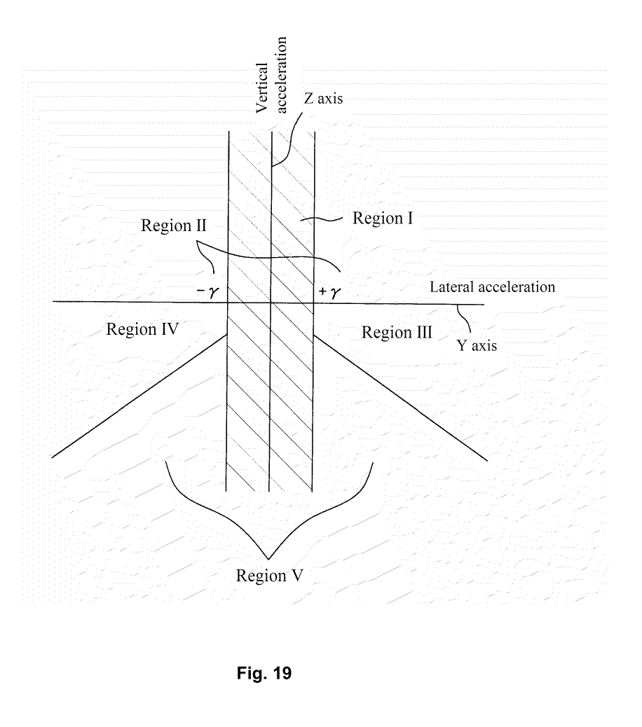

The various shapes of the minute output region I are shown for exemplary purposes only, and a minute output region I having a shape as shown in FIG. 19 may be set for example. In this example, a region −γ≦A_{Y}≦γ (γ is a positive constant) is defined as a minute output region I. That is, the minute output region I is set as a band shape extending along the Z axis (coordinate axis of the vertical acceleration A_{Z}).

In the previous embodiments, the calculation cancelling module 72 cancels a determination result by the vertical acceleration sensor 61 and the lateral acceleration sensor 62. However, the calculation cancelling module 72 may cancel the inclination angle calculated by the inclination angle calculating module 71 when the error detection condition is satisfied. The calculation cancelling module 72 may block (e.g., filter) the output of the vertical acceleration sensor 61 and/or lateral acceleration sensor 62 when the error detection condition is satisfied.

In the previous embodiments, the engine 3 is stopped by stopping all of the fuel supply operation, the fuel injection operation and the engine ignition operation, but the engine 3 may be stopped by stopping one or two of them. For example, the fuel supply operation and the fuel injection operation may be stopped while the ignition operation may be continued.

The present invention may be changed in design within a range and scope described in the claims.

As explained above, the present invention is useful for a vehicle inclination angle detector for detecting an inclination angle in a lateral direction of the vehicle, an power source control apparatus having the vehicle inclination angle detector, and a vehicle having the power source control apparatus.

What is claimed is:

1. A vehicle inclination angle detector for detecting an inclination angle in a lateral direction of a vehicle, comprising:
a vertical acceleration sensor for detecting acceleration in the vertical direction of the vehicle;
a lateral acceleration sensor for detecting acceleration in the lateral direction of the vehicle;
an inclination angle calculating module adapted to calculate an inclination angle in the lateral direction of the vehicle based on the vertical acceleration and the lateral acceleration respectively detected by the vertical acceleration sensor and the lateral acceleration sensor; and
a calculation cancelling module adapted to cancels the inclination angle calculation carried out by the inclination angle calculating module when the detected vertical acceleration and the lateral acceleration satisfy a predetermined error detection condition.

2. The vehicle inclination angle detector of claim 1, wherein the error detection condition includes a condition in which the magnitude of a synthesis vector S is less than or equal to a predetermined magnitude, the synthesis vector is equal to the sum of a vertical acceleration vector and a lateral acceleration vector, the vertical acceleration vector is a vector representative of the acceleration in the vertical direction and the lateral acceleration vector is representative of the acceleration in the lateral direction.

3. The vehicle inclination angle detector of claim 1, wherein the error detection condition includes a condition in which the end point of a synthesis vector S originating from the coordinate origin of a coordinate plane falls within a predefined minute sensor output region including the coordinate origin, wherein the synthesis vector is equal to the sum of a vertical acceleration vector and a lateral acceleration vector, and vertical acceleration is expressed on a first coordinate axis of the coordinate plane and lateral acceleration is expressed on a second coordinate axis of the coordinate plane.

4. The vehicle inclination angle detector of claim 3, wherein the minute sensor output region comprises a circular region having a predetermined radius.

5. The vehicle inclination angle detector of claim 3, wherein the minute output region comprises a rectangular region of a predetermined size.

6. The vehicle inclination angle detector of claim 1, further comprising a back-and-forth acceleration sensor for detecting acceleration in the longitudinal direction of the vehicle, wherein the calculation cancelling module cancels the inclination angle calculation by the inclination angle calculating module when the vertical acceleration, the lateral acceleration and the back-and-forth acceleration respectively detected by the vertical acceleration sensor, the lateral acceleration sensor and the back-and-forth acceleration sensor satisfy the predetermined error detection condition.

7. The vehicle inclination angle detector of claim 6, wherein the error detection condition includes a condition in which the magnitude of a synthesis vector S is less than or equal to a predetermined magnitude, the synthesis vector is equal to the sum of a vertical acceleration vector, a lateral acceleration vector, and a back-and-forth acceleration vector, wherein the vertical acceleration vector is a vector representative of the acceleration in the vertical direction, the lateral acceleration vector is representative of the acceleration in the lateral direction, and the back-and-forth acceleration vector is representative of the acceleration in the longitudinal direction.

8. The vehicle inclination angle detector of claim 6, wherein the error detection condition includes a condition in which the end point of a synthesis vector S originating from the coordinate origin of a three-dimensional coordinate space falls within a predefined minute sensor output region including the coordinate origin, wherein the synthesis vector S is equal to the sum of a vertical acceleration vector, a lateral acceleration vector, and a back-and-forth acceleration vector, and wherein vertical acceleration is expressed on a first coordinate axis, lateral acceleration is expressed on a second coordinate axis, and back-and-forth acceleration is expressed on a third coordinate axis.

9. The vehicle inclination angle detector of claim 8, wherein the minute output region comprises a spherical region having a predetermined radius.

10. The vehicle inclination angle detector of claim 8, wherein the minute output region comprises a rectangular parallelepiped region of a predetermined size.

11. The vehicle inclination angle detector of claim 6, wherein the error detection condition requires that the back-and-forth acceleration detected by the back-and-forth acceleration sensor is equal to or higher than a predetermined back-and-forth acceleration threshold value.

12. A power source control apparatus for controlling a power source of a vehicle, the power source control apparatus comprising:
a vehicle inclination angle detector comprising a vertical acceleration sensor for detecting acceleration in the vertical direction of the vehicle, a lateral acceleration sensor for detecting acceleration in the lateral direction of the vehicle, an inclination angle calculating module adapted to calculate an inclination angle in the lateral direction of the vehicle based on the vertical acceleration and the lateral acceleration respectively detected by the vertical acceleration sensor and the lateral acceleration sensor, and a calculation cancelling module adapted to cancel the inclination angle calculation carried out by the inclination angle calculating module when the detected vertical acceleration and the lateral acceleration satisfy a predetermined error detection condition;
an inclination angle determining module configured to determine whether the inclination angle of the vehicle exceeds a predetermined inclination angle threshold value based on a detection result of the vehicle inclination angle detector; and
an operation control module configured to control operation of the power source based on a determination result by the inclination angle determining unit.

13. The power source control apparatus of claim 12, wherein the inclination angle determining module includes a stop counter for determining whether the vehicle is inclined.

14. The power source control apparatus of claim 12, wherein the operation control unit includes at least one module for stopping the operation of the power source in response to a determination of the inclination angle determining module that the inclination angle of the vehicle exceeds the inclination angle threshold value.

15. The power source control apparatus of claim 14, wherein the operation control unit includes at least one module selected from the group consisting of a fuel injection control module, an ignition control module, and a fuel supply control module.

16. The power source control apparatus of claim 15, wherein the operation control unit includes at least the fuel supply control module, and the fuel supply control module is configured to stop the fuel supply operation of a fuel pump in the vehicle in response to a determination of the inclination angle determining module that the inclination angle of the vehicle exceeds the inclination angle threshold value.

17. The power source control apparatus of claim 15, wherein the operation control unit includes at least the ignition control module, and the ignition control module is configured to stop the ignition operation of an ignition coil in the vehicle in response to a determination of the inclination angle determining module that the inclination angle of the vehicle exceeds the inclination angle threshold value.

18. The power source control apparatus of claim 15, wherein the operation control module includes at least the fuel injection control module, and the fuel injection control module is adapted to stop the operation of a fuel injector in the vehicle in response to a determination of the inclination angle determining module that the inclination angel of the vehicle exceeds the inclination angle threshold value.

19. A vehicle comprising the power source control apparatus of claim 12.

20. A vehicle comprising the inclination angle detector of claim 12, wherein the error detection condition includes a condition in which the end point of a synthesis vector S originating from the coordinate origin of a coordinate plane falls within a predefined minute sensor output region including the coordinate origin, wherein the synthesis vector is equal to the sum of a vertical acceleration vector and a lateral acceleration vector, and vertical acceleration is expressed on a first coordinate axis of the coordinate plane and lateral acceleration is expressed on a second coordinate axis of the coordinate plane.

21. A vehicle comprising the power source control apparatus of claim 12. wherein the inclination angle detector further comprises a back-and-forth acceleration sensor for detecting acceleration in the longitudinal direction of the vehicle, wherein the calculation cancelling module cancels the inclination angle calculation by the inclination angle calculating module when the vertical acceleration, the lateral acceleration and the back-and-forth acceleration respectively detected by the vertical acceleration sensor, the lateral acceleration sensor and the back-and-forth acceleration sensor satisfy the predetermined error detection condition.

22. A vehicle according to claim 21, wherein the error detection condition includes a condition in which the end point of a synthesis vector S originating from the coordinate origin of a three-dimensional coordinate space falls within a predefined minute sensor output region including the coordinate origin, wherein the synthesis vector S is equal to the sum of a vertical acceleration vector, a lateral acceleration vector, and a back-and-forth acceleration vector, and wherein vertical acceleration is expressed on a first coordinate axis, lateral acceleration is expressed on a second coordinate axis, and back-and-forth acceleration is expressed on a third coordinate axis.
